(19) United States
(12) Patent Application Publication
(10) Pub. No.: US 2019/0065974 A1
(43) Pub. Date: Feb. 28, 2019

(54) INFERENCE DEVICE, INFERENCE SYSTEM, AND INFERENCE METHOD

(71) Applicant: AXELL CORPORATION, Tokyo (JP)

(72) Inventor: Masashi MICHIGAMI, Tokyo (JP)

(73) Assignee: AXELL CORPORATION, Tokyo (JP)

(21) Appl. No.: 16/117,701

(22) Filed: Aug. 30, 2018

(30) Foreign Application Priority Data
Aug. 30, 2017 (JP) 2017-166123
Jul. 23, 2018 (JP) 2018-137749

(51) Int. Cl. G06N 5/04; G06N 3/08; G06N 3/04

(52) U.S. Cl. CPC G06N 5/046; G06N 3/0454; G06N 3/0481; G06N 3/084

(57) ABSTRACT

An inference device includes a processor configured to execute a process including: acquiring of a learned model in which a parameter is adjusted by using a first neural network employing a nonlinear function as an activation function, the parameter including at least one of a weight and a bias of coupling between neurons included in the first neural network; setting of a parameter in a second neural network employing an approximation polynomial of the nonlinear function as an activation function in accordance with the learned model; and performing of inference processing on encrypted data as encrypted by using the second neural network in response to the encrypted data being input.

### CROSS-REFERENCE TO RELATED APPLICATIONS

This application is based on and claims priority under 35 USC 119 from Japanese Patent Application No. 2017-166123 filed on Aug. 30, 2017 and Japanese Patent Application No. 2018-137749 filed on Jul. 23, 2018, the entire content of which is incorporated herein by reference.

### BACKGROUND

### Technical Field

The embodiments discussed herein relates to an inference device, an inference system, and an inference method.

### Related Art

In a client-server model, a technique for transmitting and receiving encrypted data between a server device and a client device to prevent leakage of high confidential information such as personal information in processing data on the server side is known.

In the client-server model, data is encrypted and is transmitted and received between the server device and a client device. In this case, the server device performs various processing after decrypting the encrypted data received from the client device. The server device encrypts a processing result and transmits it to the client device. The client device decrypts the encrypted processing result received from the server device to obtain a plaintext processing result.

To prevent leakage of information, the encrypted data is sometimes processed without decrypting the data at a server device. Homomorphic encryption scheme is known as a technique for processing encrypted data as encrypted.

The server device can process data in an encrypted state as encrypted via the homomorphic encryption. In addition, the client device acquires the encrypted data after processing from the server device and decrypts the acquired encrypted data. Therefore, the client device can obtain the same processing result as when the data is processed in plaintext. In the following description, the encrypted state as encrypted is simply referred to as an encrypted state.

One of technical fields that require processing using the client-server model is inference processing using a Neural network (Artificial neural network; ANN). This is due to an enlarged scale of parameters of a learned model of the neural network that makes it difficult to execute a computation in the inference processing with a resource of the client device. Therefore, it is required to execute the inference processing at the server device using the resource of the server device capable of performing a large-scale computation by employing the client-server model.

A neural network includes a plurality of neurons coupled to form an input layer, an intermediate layer, and an output layer. The neural network may include multiple intermediate layers. Machine learning using a neural network including multiple intermediate layers is called deep learning. Deep learning is used for recognition processing of images, characters, sounds, or the like.

As a related art, a ciphertext processing device that acquires a first polynomial in which first text data is polynomialized in a first order and encrypted with a first public key is known. The ciphertext processing device acquires a first square value polynomial in which square value vector data of each component of the first text data is polynomialized in the first order and is encrypted with the first public key. Furthermore, the ciphertext processing device acquires a second polynomial in which second text data is polynomialized in a second order and is encrypted with the first public key, and a second square value polynomial in which square value vector data of each component of second text data is polynomialized in the second order and is encrypted with the first public key. The ciphertext processing device determines whether the second text data is included in the first text data by using the first polynomial, the first square value polynomial, the second polynomial, and the second square value polynomial.

As another related art, a server device that executes computations encrypted data via the homomorphic encryption on calculation sections other than an activation function is known. A client device decrypts the data and executes computations for the calculation section related to the activation function. Each time the server device performs the computations of the activation function, the server device inquires a computation result to the client side.

As another related art, there is a kind of a homomorphic encryption called a Somewhat Homomorphic Encryption (SHE). The Somewhat Homomorphic Encryption is a homomorphic encryption in which a predetermined number of additions and multiplications are established in the encrypted state. For example, a calculation of an inner product of vectors is configured of a first order multiplication and a plurality of additions thereof, so that the Somewhat Homomorphic Encryption can be used. Therefore, a nonlinear function included in the neural network is approximated to a linear function expressed by the number of additions and multiplications capable of being calculated by the Somewhat Homomorphic Encryption. Therefore, various processes executed in the neural network may be executed in a state where data is encrypted (see, for example, JP-A-2015-184594, US 2016/0350648 A1, and C. Orlandi, A. Piva, and M. Barni, Research Article Oblivious Neural Network Computing via Homomorphic Encryption, Internet <http://clem.dii.unisi.it/˜-vipp/files/publications/S1687416107373439.pdf>).

### SUMMARY

In the inference art described above, an amount of the computation may increase and a system load may be large since the computation is executed via the homomorphic encryption scheme in a system using the neural network.

An aspect of the present invention may provide a system using a neural network via a homomorphic encryption scheme for reducing a system load.

One of the inference devices disclosed in this specification is an inference device including a processor. The processor is configured to execute a process including: acquiring of a learned model in which a parameter is adjusted by using a first neural network employing a nonlinear function as an activation function, the parameter including at least one of a weight and a bias of coupling between neurons included in the first neural network; setting of a parameter in a second neural network employing an approximation polynomial of the nonlinear function as an activation function in accordance with the learned model; and performing of inference processing on encrypted data as encrypted by using the second neural network in response to the encrypted data being input.

According to the embodiment, in a system using the neural network via the homomorphic encryption scheme, a system load may be reduced.

### BRIEF DESCRIPTION OF THE DRAWINGS

FIG. 1 is a diagram illustrating a configuration of an example of a neural network;

FIG. 2 is a functional block diagram illustrating an example of a system of the neural network;

FIG. 3 is a flowchart illustrating an example of processing in the system of the neural network;

FIG. 4A is a diagram illustrating an example of a neuron included in the neural network;

FIG. 4B is a diagram illustrating an example of a neuron included in the neural network;

FIG. 5A is a diagram illustrating an example of an approximation polynomial of a nonlinear function;

FIG. 5B is a diagram illustrating an example of an approximation polynomial of a nonlinear function;

FIG. 6 is a block diagram illustrating an example of a computing apparatus; and

FIG. 7 is a diagram illustrating a correct answer rate of image recognition processing using the neural network.

### DETAILED DESCRIPTION

Exemplary embodiments of an inference device will be described.

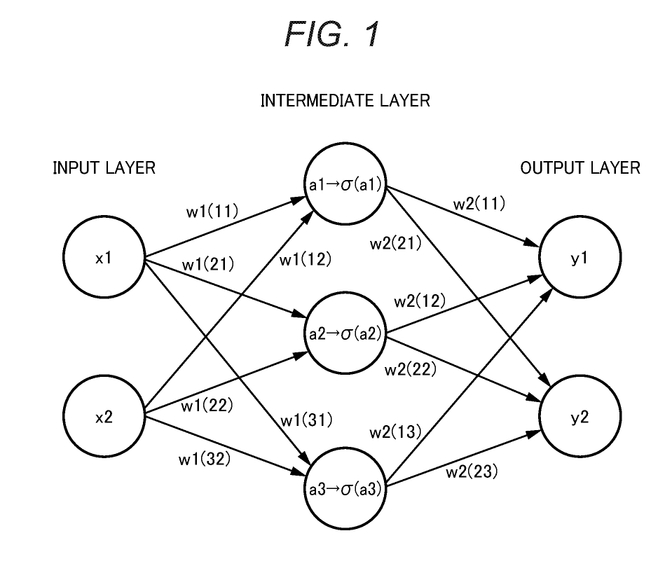

FIG. 1 is a diagram illustrating a configuration of an example of a neural network.

Compute processing performed in the neural network will be described with reference to FIG. 1.

Outputs of neurons of an input layer are respectively weighted by a weighting coefficient w1 and input to each neuron of an intermediate layer. The neurons of the intermediate layer calculate a1, a2, and a3 by taking a sum of input respective weighted values. For example, a1 is calculated by equation (1).

a1=x1×w1(11)+x2×w1(12) (1)

In addition, outputs of neurons of the intermediate layer are respectively weighted by a weighting coefficient w2 and input to each output layer. Each neuron of the output layer calculates y1 and y2 by taking a sum of the input respective weighted values. For example, y1 is calculated by equation (2).

y1=σ(a1)×w2(11)+σ(a2)×w2(12)+σ(a3)×w2(13) (2)

In each neuron of the intermediate layer, as illustrated in FIG. 1, a predetermined calculation is executed by using an activation function σ on the calculation results a1, a2, and a3. The activation function is a function that converts the sum of input signals into an output signal.

In the neural network, a nonlinear function is used as the activation function. This means that in a case where the linear function is used as the activation function, the output is in a form of a linear combination. Then, the neural network including a plurality of intermediate layers becomes equivalent to a neural network having no intermediate layer.

Types of the activation functions include a Sigmoid function illustrated in equation (3), a Rectified Linear Unit (ReLU) function illustrated in equation (4), and the like.

σ(u)=1/(1+exp(−u)) (3)

σ(u)=u(u>0),0(u≤0) (4)

In the inference processing using the system of the neural network, in order to prevent the leakage of information, it is conceivable to process data in an encrypted state by using homomorphic encryption.

However, as described above, the calculation of the neural network includes the calculation of the nonlinear function. Therefore, in the homomorphic encryption that can only be multiplied and added, the calculation processing of the neural network cannot be executed.

Therefore, it is conceivable to execute the calculation of the neural network on the homomorphic encryption by using an approximation polynomial of the nonlinear function as the activation function included in the neural network. However, there is a problem that if the homomorphic encryption is used as the activation function in the system of the neural network including a learning device and the inference device, a load of the system increases.

In order to solve the problem, the inference device according to the embodiment sets a parameter of a learned model adjusted by using the neural network employing the nonlinear function as the activation function to the neural network which employs the approximation polynomial of the nonlinear function as the activation function. Then, the inference device executes the inference processing. In the following description, the neural network employing the approximation polynomial of the nonlinear function as the activation function is simply referred to as a second neural network.

Therefore, the inference device according to the embodiment reduces a load of machine learning executed by the learning device. That is, the inference device according to the embodiment can suppress a system load in the system of the neural network using the homomorphic encryption in the inference processing in order to prevent the leakage of the information.

A homomorphic encryption scheme may be the homomorphic encryption capable of calculating the approximation polynomial. In a case where the approximation polynomial includes four arithmetic operations, a Somewhat homomorphic encryption, a fully homomorphic encryption, or the like capable of calculating multiplication and addition of a ciphertext may be used. In addition, in a case where the approximation polynomial includes only multiplication and addition, an additive homomorphic encryption, the Somewhat homomorphic encryption, or the fully homomorphic encryption capable of calculating the addition of the ciphertext may be used.

Moreover, since the Somewhat homomorphic encryption or the fully homomorphic encryption can perform multiplication and addition, arbitrary calculation can be executed. In addition, in the additive homomorphic encryption, it is possible to execute the multiplication by performing addition processing a plurality of times.

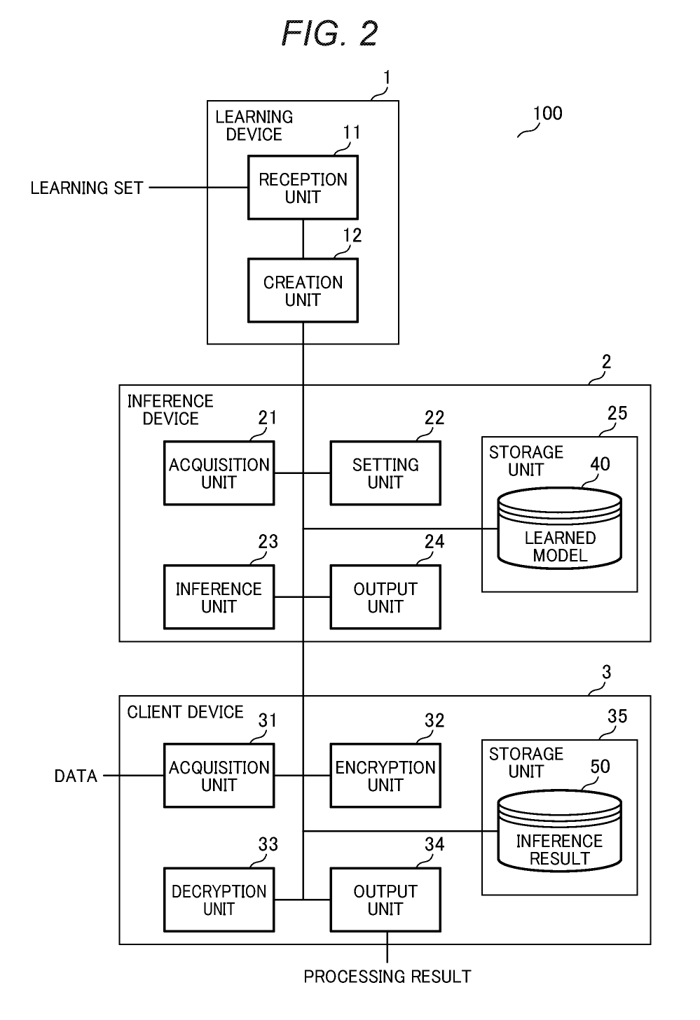

FIG. 2 is a functional block diagram illustrating an example of a system of the neural network.

The system (inference system) of the neural network according to the embodiment will be described with reference to FIG. 2. In the following description, the neural network used for image recognition processing will be described as an example. However, the system of the neural network according to the embodiment is not limited to the example and may be used for other processes such as conversation, driving support, and prediction.

The system of the neural network 100 includes a learning device 1, an inference device 2, and a client device 3. The learning device 1 is, for example, an information processing device owned by a service provider of the inference processing. In addition, the inference device 2 is, for example, an information processing device used as a server device in a client-server model. The client device 3 is, for example, an information processing device owned by a user who uses the inference processing.

The learning device 1, the inference device 2, and the client device 3 are connected to each other so as to be communicable with each other via network.

The learning device 1 includes a reception unit 11 and a creation unit 12.

The reception unit 11 receives, for example, an input of a learning set storing a set of combinations indicating a target value corresponding to an input value.

The creation unit 12 creates a learned model 40 obtained by adjusting a parameter including at least one of a weight and a bias of coupling between respective neurons included in the neural network by using the first neural network employing the nonlinear function as the activation function. The parameter included in the learned model 40 includes at least one of the weight and the bias of coupling between respective neurons for weighting the input value for biasing activation of the output signal. In the following description, the first neural network employing the nonlinear function as the activation function is simply referred to as the first neural network.

The creation unit 12 executes supervised learning for adjusting the parameter of the first neural network by using the learning set received by the reception unit 11 as an input. For example, when learning processing is performed by using the learning set, the creation unit 12 iteratively adjusts the parameter of the neural network so as to output the target value corresponding to the input value by using error back propagation. Therefore, the creation unit 12 outputs an adjusted parameter as the learned model 40.

Moreover, the creation unit 12 may read unsupervised data, execute unsupervised learning to adjust the parameter of the first neural network, and create the learned model 40. In addition, the creation unit 12 may execute reinforcement learning to adjust the parameter of the first neural network and create the learned model 40 so as to maximize a future value. The learning device 1 may execute at least one of the supervised learning, the unsupervised learning, and the reinforcement learning.

As described above, the learning device 1 executes the learning processing by using the first neural network employing the nonlinear function as the activation function in the creation unit 12. This is because the machine learning is processed by the learning device 1 does not transmit information to a network and the server device. Therefore, the learning device 1 preferentially reduces an amount of calculation in the learning processing rather than preventing the leakage of the information on the network and the server device.

That is, in the system of the neural network according to the embodiment, in the learning processing, the amount of the calculation is reduced in the learning processing using the first neural network. Since the learning processing executes calculation of iterative parameter adjustment by using the error back propagation, the amount of the calculation is larger than that of the inference processing processed by forward propagation. Therefore, in the system of the neural network according to the embodiment, the first neural network is used in the learning processing. Thus, the system of the neural network according to the embodiment reduces the amount of the calculation per iteration of calculation and efficiently suppresses the load of the system of the neural network.

The inference device 2 includes an acquisition unit 21, a setting unit 22, an inference unit 23, an output unit 24, and a storage unit 25. The storage unit 25 stores the learned model 40.

The acquisition unit 21 acquires the learned model 40 obtained by adjusting the parameter including at least one of the weight and the bias of coupling between respective neurons included in the neural network by using the first neural network employing the nonlinear function as the activation function. Then, the acquisition unit 21 may store the acquired learned model 40 in the storage unit 25.

The setting unit 22 sets a parameter in the second neural network employing the approximation polynomial of the nonlinear function as the activation function in accordance with the learned model 40. That is, the setting unit 22 sets at least one of the weight and the bias of coupling between respective neurons included in the second neural network.

The inference unit 23 executes the inference processing the encrypted data as encrypted by using the second neural network when the encrypted data is input. In this case, the inference unit 23 executes the inference processing by performing the calculation of the homomorphic encryption by using the encrypted data as encrypted. The encrypted data is input from the client device 3 that executes encryption processing and decryption processing by using the homomorphic encryption.

The first neural network and the second neural network are, for example, a Convolutional Neural Network (CNN) that performs a convolution calculation. The convolutional neural network executes the inference processing by using a convolution layer for extracting characteristics of the input data, a pooling layer for executing compress processing, and an all-coupling layer of a last stage by executing convolution processing by a filter for a two-dimensional input. The convolutional neural network is mainly used for image recognition.

The inference unit 23 executes calculation using the convolutional neural network. The convolutional neural network can be represented by addition and multiplication in digital signal processing. Therefore, the inference unit 23 can execute the inference processing using the homomorphic encryption capable of executing only addition and multiplication. Moreover, the inference unit 23 is not limited to the convolutional neural network, but may also perform the calculation using another neural network within a range that can be calculated by the homomorphic encryption.

Other neural networks include, for example, a Recurrent Neural Network (RNN) and a supervised neural network of all-in-all (feed forward). In addition, other the neural networks include an auto-encoder and an unsupervised neural network such as a Boltzmann machine.

As described above, the homomorphic encryption includes types such as additive the homomorphic encryption, the somewhat homomorphic encryption, and the fully homomorphic encryption. The additive homomorphic encryption can execute only addition. The somewhat homomorphic encryption can execute addition and a finite number of multiplications. The fully homomorphic encryption can execute addition and multiplication. Therefore, the fully homomorphic encryption can execute arbitrary processing by combining addition and multiplication. A processing speed is the fastest in the additive homomorphic encryption and slowing down in the order of the somewhat homomorphic encryption and the fully homomorphic encryption.

In the inference unit 23, when the additive homomorphic encryption is used in order to give priority to improvement of the processing speed of the inference processing and suppression of a processing load, the addition processing may be performed a plurality of times instead of multiplication. Therefore, the inference unit 23 can execute the calculation of the convolution neural network using the additive homomorphic encryption.

In the inference unit 23, when the convolutional neural network and other neural networks are executed, the somewhat homomorphic encryption may be used. In the inference unit 23, when the somewhat homomorphic encryption is used, a degree and the number of times of addition of the approximation polynomial of the nonlinear function included in the calculation of the second neural network may be adjusted depending on which of the improvement of the processing speed of the inference processing, suppression of the processing load, and processing accuracy is prioritized.

That is, in the approximation polynomial of the nonlinear function included in the calculation of the second neural network, when priority is given to the improvement of the processing speed of the inference processing and suppression of the processing load, adjustment of at least one of lowering the degree and the number of times of addition is performed. In addition, in the approximation polynomial of the nonlinear function included in the calculation of the second neural network, when priority is given to the improvement of the processing speed of the inference processing and suppression of the processing load, adjustment of at least one of increasing the degree and the number of times of addition is performed. If the degree of the approximation polynomial is increased and the number of times of addition is increased, the approximation polynomial further approximates to an original nonlinear function, so that the accuracy of the inference processing improves.

In the inference unit 23, when another neural network including a complicated addition compared to the convolutional neural network is executed, the fully homomorphic encryption may be used. In addition, in the inference unit 23, even when the convolutional neural network is executed, the fully homomorphic encryption may be used.

The inference unit 23 outputs an inference result in an encrypted state as a result of executing the inference processing on the encrypted data as encrypted. Since the inference unit 23 performs the inference processing on the encrypted data as encrypted by using the homomorphic encryption, the inference result is also output in the encrypted state.

The output unit 24 outputs the encrypted inference result obtained by the inference processing to the client device 3.

The client device 3 includes an acquisition unit 31, an encryption unit 32, a decryption unit 33, an output unit 34, and a storage unit 35. The storage unit 35 stores an inference result 50.

The acquisition unit 31 acquires data of the target of the inference processing. The data of the target of the inference processing is data of a recognition target such as images, characters, sounds, or the like.

The encryption unit 32 performs the encryption processing via the homomorphic encryption on the data of the target of the inference processing. Therefore, the encryption unit 32 outputs the encrypted data.

When the encrypted inference result is input, the decryption unit 33 executes the decryption processing of the homomorphic encryption on the encrypted inference result. The decryption unit 33 may store the decrypted inference result 50 to the storage unit 35.

The output unit 34 outputs the encrypted data obtained by the encryption unit 32 to the inference device 2. The output unit 34 may output the inference result 50 to an outside.

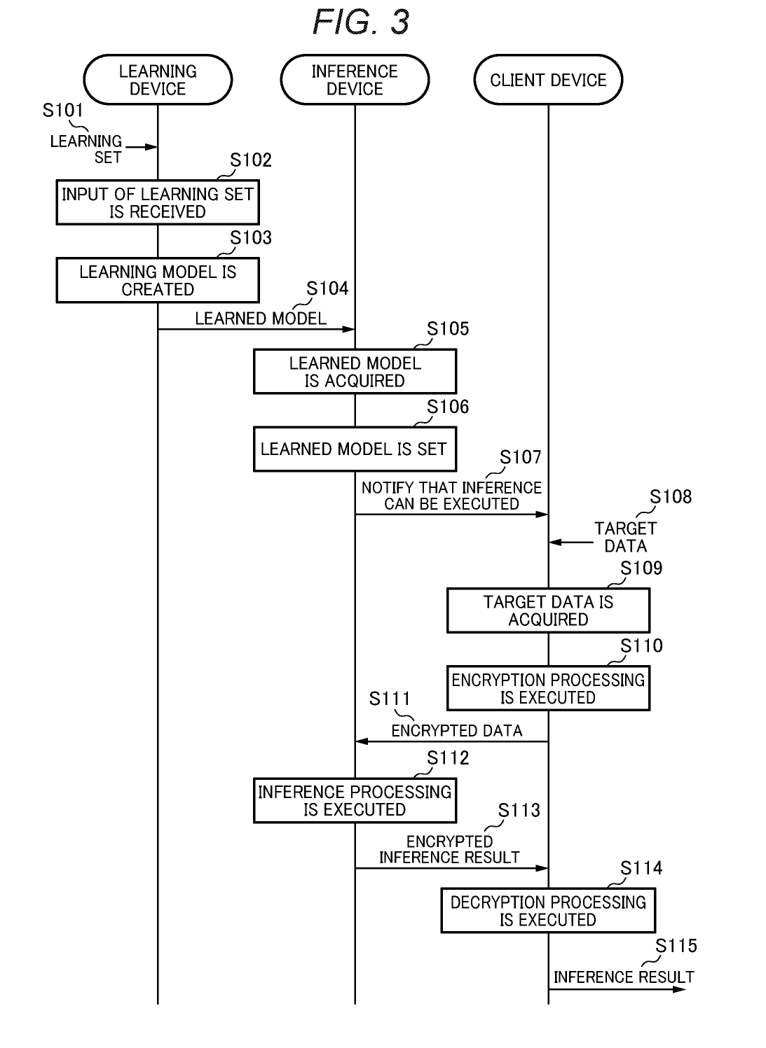

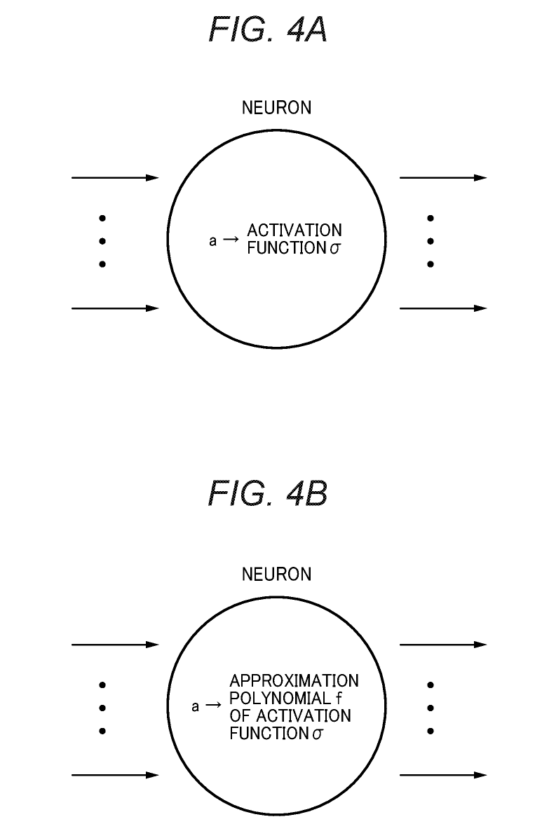

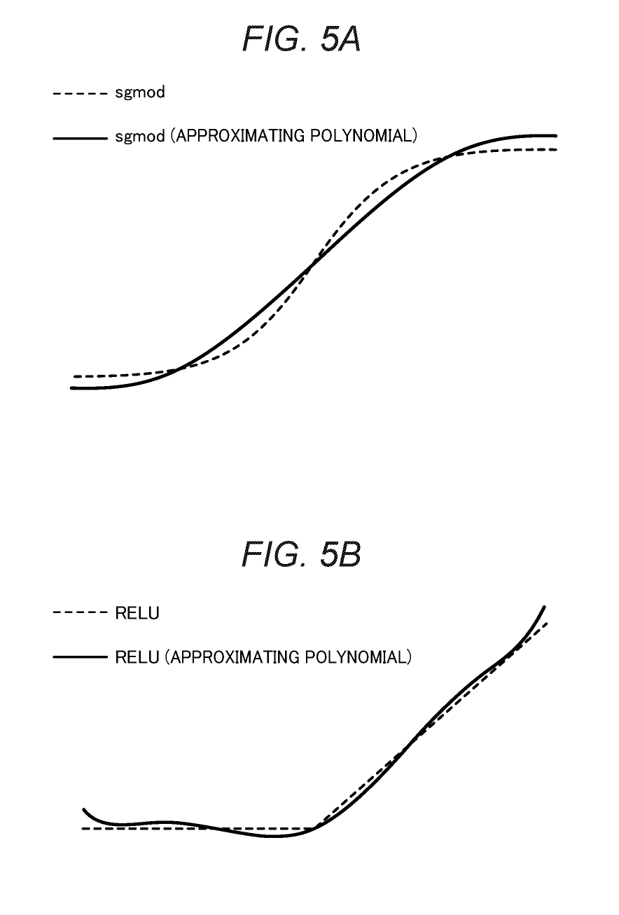

FIG. 3 is a flowchart illustrating an example of processing in the system of the neural network. FIGS. 4A and 4B are diagrams illustrating examples of a neuron included in the neural network. FIGS. 5A and 5B are diagrams illustrating examples of an approximation polynomial of a nonlinear function.

Processing in the system of the neural network will be described with reference to FIGS. 3 to 5B. The processing in the system of the neural network is executed, for example, by processors of the learning device 1, the inference device 2, and the client device 3. In the following description, the processor of the learning device 1, the processor of the inference device 2, and the processor of the client device 3 are simply also referred to as the learning device 1, the inference device 2, and the client device 3.

The description will be given with reference to FIG. 3.

When the learning set is input (S101), the learning device 1 receives the input of the learning set (S102). The learning device 1 acquires the learned model 40 obtained by adjusting the parameter including at least one of the weight and the bias of the coupling between respective neurons included in the neural network by using the first neural network employing the nonlinear function as the activation function (S103). Then, the learning device 1 outputs the created learned model 40 to the inference device (S104).

The description will be given with reference to FIGS. 4A, 4B, 5A and 5B.

In the creation processing of the learned model 40 in the learning device 1, data of the learning set not encrypted is used. Therefore, for example, as illustrated in FIG. 4A, the learning device 1 can employ the nonlinear function as the activation function a of each neuron. For example, in a case where the sigmoid function is employed as the activation function a, the learning device 1 creates the learned model 40 using a function indicated by a dotted line of FIG. 5A corresponding to equation (3). In a case where the ReLU function is employed as the activation function σ, the learning device 1 creates the learned model 40 using a function indicated by a dotted line of FIG. 5B corresponding to equation (4).

The description will be given with reference to FIG. 3.

The inference device 2 acquires the learned model 40 (S105). In this case, the inference device 2 may store the learned model 40 in the storage unit 25. The inference device 2 sets the parameter of the second neural network in which the approximation polynomial of the nonlinear function is employed as the activation function in accordance with the learned model 40 (S106). The inference device 2 notifies the client device 3 that the inference processing can be performed (S107).

Upon being notified from the inference device 2 that the inference can be made, the client device 3 receives the input of the target of the inference processing. When the data of the target of the inference processing is input (S108), the client device 3 acquires the data of the target of the inference processing (S109). The data of the target of the inference processing is images, characters, sounds, or the like. The data of the target of the inference processing may be input by a user, for example, using an imaging device such as a camera, an input device such as a keyboard, and a sound collecting device such as a microphone. In the following description, the data of the target of the inference processing is simply referred to as target data.

The client device 3 executes the encryption processing of the homomorphic encryption on the target data (S110). The client device 3 outputs the encrypted target data to the inference device 2 (S111). In the following description, the encrypted target data is simply also referred to as encrypted data.

When the encrypted data is input, the inference device 2 executes the inference processing on the encrypted data as encrypted by using the second neural network (S112). The inference device 2 outputs an encrypted inference result obtained by the inference processing to the client device (S113).

The description will be given with reference to FIGS. 4A, 4B, 5A and 5B.

In the inference processing in the inference device 2, the calculation is processed on the encrypted data as encrypted. Therefore, for example, as illustrated in FIG. 4B, the inference device 2 employs the approximation polynomial f of the activation function a that is the nonlinear function as the activation function of respective neurons. For example, in a case where the approximation polynomial f of the sigmoid function as the activation function is employed, the inference device 2 executes the inference processing using a function indicated by a solid line of FIG. 5A corresponding to the following equation (5).

fsig(x)=8*10⁻¹⁵x⁶+2*10⁻⁵x⁵−1*10⁻¹²x⁴−0.0028x³+4*10⁻¹¹x²+0.1672x+0.5 (5)

In a case where the approximation polynomial f of the ReLU function is employed as the activation function, the inference device 2 executes the inference processing using a function indicated by a solid line of FIG. 5B corresponding to the following equation (6).

fre(x)=5*10⁻⁸x⁶−9*10⁻²⁰x⁵−8*10⁻⁵x⁴+9*10⁻¹⁷x³+0.0512x²+0.5x (6)

As described above, the inference device 2 can perform the inference processing on the target data as encrypted using the homomorphic encryption by approximating the activation function to the polynomial.

The description will be described with reference to FIG. 3.

When the encrypted inference result is input, the client device 3 executes the decryption processing of the homomorphic encryption on the encrypted inference result (S114). The client device 3 outputs, for example, the inference result to a display device or the like (S115).

Moreover, S108 to S111 may be performed prior to S101 to S107. In this case, when the encrypted data is acquired, the inference device 2 may store the encrypted data in the storage unit 25. When the inference processing is executed in S112, the inference device 2 executes the inference processing using the encrypted data stored in the storage unit 25. In this case, in S107, the inference device 2 does not have to notify the client device 3 that the inference can be executed.

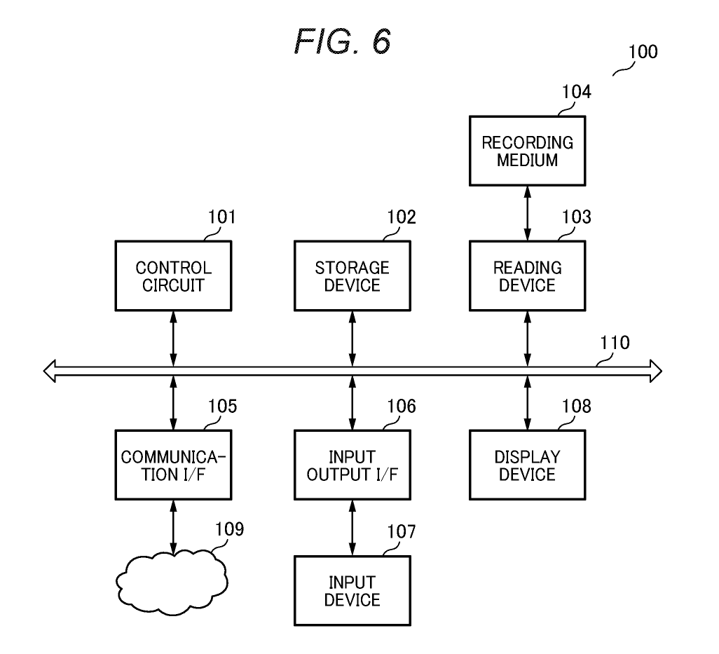

FIG. 6 is a block diagram illustrating an example of a computing apparatus. A configuration of a computing apparatus 100 will be described with reference to FIG. 6.

The computing apparatus 100 is an information processing device including a control circuit 101, a storage device 102, a reading device 103, a recording medium 104, a communication interface 105, an input and output interface 106, an input device 107, and a display device 108. In addition, the communication interface 105 is connected to a network 109. Respective configuration elements are connected to each other by a bus 110. The learning device 1, the inference device 2, and the client device 3 can be configured by appropriately selecting a part or all of the components described in the computing apparatus 100.

The control circuit 101 controls the entire computing apparatus 100. The control circuit 101 is, for example, a processor such as a Central Processing Unit (CPU), a Field Programmable Gate Array (FPGA), or a Programmable Logic Device (PLD).

The control circuit 101 functions, for example, as the reception unit 11 and the creation unit 12 in the learning device 1 illustrated in FIG. 2. The control circuit 101 functions, for example, as the acquisition unit 21, the setting unit 22, the inference unit 23, and the output unit 24 in the inference device 2 illustrated in FIG. 2. Furthermore, the control circuit 101 functions, for example, as the acquisition unit 31, the encryption unit 32, the decryption unit 33, and the output unit 34 in the client device 3 illustrated in FIG. 2.

The storage device 102 stores various data. The storage device 102 is, for example, a memory such as a Read Only Memory (ROM) and a Random Access Memory (RAM), a Hard Disk (HD), or the like. In addition, the storage device 102 functions, for example, as the storage unit 25 in the inference device 2 of FIG. 2. Furthermore, the storage device 102 functions, for example, as the storage unit 35 in the client device 3 of FIG. 2.

In addition, the ROM stores a program such as a boot program. The RAM is used as a work area of the control circuit 101. The HD stores programs such as an OS, an application program, and firmware and data.

The storage device 102 may store a learning program that causes the control circuit 101 to function as, for example, the reception unit 11 and the creation unit 12 of the learning device 1. The storage device 102 may store an inference program that causes the control circuit 101 to function as, for example, the acquisition unit 21, the setting unit 22, the inference unit 23, and the output unit 24 of the inference device 2. The storage device 102 may store a client program that causes the control circuit 101 to function as, for example, the acquisition unit 31, the encryption unit 32, the decryption unit 33, and the output unit 34 of the client device 3.

The learning device 1, the inference device 2, and the client device 3 read out the program stored in the storage device 102 to the RAM when various processes are performed. The program read out to the RAM is executed by the control circuit 101, so that the learning device 1, the inference device 2, and the client device 3 respectively execute the learning processing, the inference processing, and the client processing.

The learning processing includes, for example, reception processing and creation processing executed by the learning device 1. The inference processing includes, for example, acquisition processing, setting processing, inference processing, and output processing executed by the inference device 2. The client processing includes, for example, acquisition processing, encryption processing, decryption processing, and output processing executed by the client device 3.

Moreover, each program described above may be stored in the storage device of a server on the network 109 as long as the control circuit 101 can access each program via the communication interface 105.

The reading device 103 is controlled by the control circuit 101 to read/write of data of the detachable recording medium 104. The reading device 103 is, for example, various disk drives, a Universal Serial Bus (USB), or the like.

The recording medium 104 stores various data. The recording medium 104 stores, for example, at least one of a learning program, an inference program, and a client program. Furthermore, the recording medium 104 may store at least one of the learning set, the learned model 40, and the inference result 50 illustrated in FIG. 2. The inference result 50 may be stored in the recording medium 104 in the encrypted state. The recording medium 104 is connected to the bus 110 via the reading device 103 and the control circuit 101 controls the reading device 103, so that read/write of the data is performed.

In a case where the learned model 40 is recorded in the recording medium 104, the inference device 2 may acquire the learned model by reading the learned model from the recording medium 104. In a case where the inference result 50 is recorded in the recording medium 104, the client device 3 may acquire the inference result 50 by reading the inference result 50 from the recording medium 104.

In addition, the recording medium 104 is, for example, a non-transitory recording medium such as a SD Memory Card, a Floppy Disk (FD), a Compact Disc (CD), a Digital Versatile Disk (DVD), a Blu-ray Disk (BD: registered trademark), a flash memory, or the like.

The communication interface 105 causes the computing apparatus 100 and another device to connect to each other via the network 109 to be communicable with each other. In addition, the communication interface 105 may include an interface having a function of a wireless LAN and an interface having a short-range wireless communication function. The wireless LAN interface may support, for example, Wi-Fi (registered trademark) as a wireless LAN standard. The short-range wireless interface may support, for example, Bluetooth (registered trademark) as a short-range wireless communication standard. The LAN stands for Local Area Network.

The communication interface 105 functions as, for example, the acquisition unit 21 and the output unit 24 in the inference device 2 illustrated in FIG. 2. Furthermore, the communication interface 105 functions as, for example, the acquisition unit 31 and the output unit 34 in the client device 3 illustrated in FIG. 2.

The input and output interface 106 is connected to, for example, the input device 107 such as a keyboard, a mouse, and a touch panel, and outputs a signal input via the bus 110 to the control circuit 101 when a signal indicating various kinds of information is input from the connected input device 107. In addition, when a signal indicating various kinds of information is output from the control circuit 101 via the bus 110, the input and output interface 106 outputs the signal to various connected devices.

The input and output interface 106 functions as, for example, the reception unit 11 in the learning device 1 illustrated in FIG. 2. In addition, the input and output interface 106 functions as, for example, the acquisition unit 21 and the output unit 24 in the inference device 2 illustrated in FIG. 2. Furthermore, the input and output interface 106 functions as, for example, the acquisition unit 31 and the output unit 34 in the client device 3 illustrated in FIG. 2.

The learning device 1 may receive an input such as the learning set via the input device 107. The inference device 2 may receive an input such as a request for executing the inference processing via the input device 107. The client device 3 may receive an input or the like of the data of the target of the inference processing via the input device 107.

The display device 108 displays various kinds of information. The display device 108 may display information for receiving an input on the touch panel. The display device 108 is connected to, for example, the output unit 34 illustrated in FIG. 2 and may display information corresponding to the inference result 50 which is decrypted by the decryption unit 33.

In addition, the input and output interface 106, the input device 107, and the display device 108 may function as a Graphical User Interface (GUI). Therefore, the computing apparatus 100 receives an intuitive operation by the touch panel, the mouse, or the like.

The network 109 is, for example, a LAN, wireless communication, an Internet, or the like, and causes the computing apparatus 100 and another device to connect to each other to be communicable with each other. The learning device 1, the inference device 2, and the client device 3 may be connected to each other so as to be communicable with each other via the network 109.

As described above, the inference device 2 executes the inference processing by the calculation of the neural network employing the approximation polynomial of the nonlinear function as the activation function by using the learned model obtained by the calculation of the neural network employing the nonlinear function as the activation function. Since the inference device 2 employs the approximation polynomial as the activation function in the inference processing, the inference processing can be performed by the calculation of the homomorphic encryption. Therefore, the inference device 2 can reduce the processing load in the learning device and reduce the system load in the system of the neural network using the homomorphic encryption.

The inference device 2 executes the inference processing on the encrypted data as encrypted input from the client device 3 that executes the encryption processing and the decryption processing of the homomorphic encryption. The inference device 2 outputs the encrypted inference result obtained by the inference processing to the client device. Therefore, the inference device 2 executes the inference processing on the data as encrypted by using the homomorphic encryption in the system of the neural network using the homomorphic encryption, so that leakage of information may be prevented.

The inference device 2 executes the calculation using the convolutional neural network. The convolution calculation can be represented by addition and multiplication in the digital signal processing. Therefore, the inference device 2 can execute the inference processing using the homomorphic encryption capable of executing at least one of addition and multiplication in which the processing speed is relatively high in the homomorphic encryption.

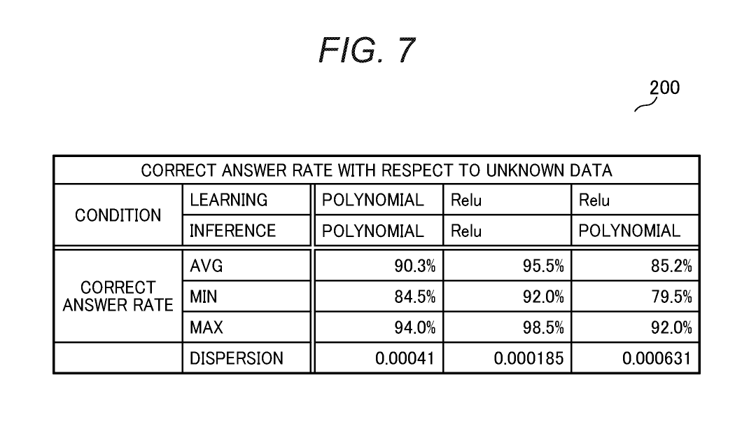

FIG. 7 is a diagram illustrating a correct answer rate of image recognition processing using the neural network. The correct answer rate of the inference processing in the system of the neural network according to the embodiment will be described with reference to FIG. 7.

A correct answer rate table 200 is a table indicating a relationship between the activation function employed by the learning processing and the inference processing and the correct answer rate in the image recognition processing using the convolutional neural network. In the correct answer rate table 200, an average value, a minimum value, and a maximum value of the correct answer rate, which are obtained by performing experiments executing a plurality of times of the image recognition processing, are indicated.

A polynomial-polynomial column of the correct answer rate table 200 indicates the correct answer rate when the approximation polynomial of the Relu function that is the nonlinear function is employed as the activation function in the learning processing and the inference processing. A Relu-Relu column of the correct answer rate table 200 indicates the correct answer rate when the Relu function that is the nonlinear function is employed as the activation function in the learning processing and the inference processing. A Relu-polynomial column of the correct answer rate table 200 indicates the correct answer rate when the Relu function that is the nonlinear function is employed as the activation function in the learning processing and the approximation polynomial of the Relu function is employed as the activation function in the inference processing.

If the Relu-polynomial column is referred, it can be seen that the correct answer rate when the image recognition processing is performed by using the Relu function in the learning processing and the approximation polynomial in the inference processing is 85.2% at average, 79.5% at a minimum, and 92.0% at a maximum. Therefore, the experimental results illustrated in the correct answer rate table 200 indicate that an image can be recognized using the system of the neural network using the Relu function in the learning processing and the approximation polynomial in the inference processing.

Moreover, embodiments are not limited to the forms described above, and various modifications or variations can be adopted in a range without departing from the gist of the present embodiment.

What is claimed is:

1. An inference device comprising:
a processor configured to execute a process including:
acquiring of a learned model in which a parameter is adjusted by using a first neural network employing a nonlinear function as an activation function, the parameter including at least one of a weight and a bias of coupling between neurons included in the first neural network;
setting of a parameter in a second neural network employing an approximation polynomial of the nonlinear function as an activation function in accordance with the learned model; and
performing of inference processing on encrypted data as encrypted by using the second neural network in response to the encrypted data being input.

2. The inference device according to claim 1,
wherein the encrypted data is input from a client device that performs encryption processing and decryption processing via a homomorphic encryption scheme,
wherein the performing of the inference processing includes:
performing of the inference processing by computing via the homomorphic encryption scheme, and
wherein the process further includes:
outputting of an encrypted inference result obtained by the inference processing to the client device.

3. The inference device according to claim 1,
wherein the first neural network and the second neural network are convolutional neural networks.

4. The inference device according to claim 2,
wherein the first neural network and the second neural network are convolutional neural networks.

5. An inference system comprising:
a learning device; and
an inference device,
wherein the learning device includes a first processor configured to execute a process including:
creating a learned model in which a parameter is adjusted by using a first neural network employing a nonlinear function as an activation function, the parameter including at least one of a weight and a bias of coupling between neurons included in the first neural network, and
wherein the inference device includes a second processor configured to execute a process including:
acquiring the learned model,
setting a parameter in a second neural network employing an approximation polynomial of the nonlinear function as an activation function in accordance with the learned model, and
performing inference processing on encrypted data as encrypted by using the second neural network in response to the encrypted data being input.

6. The inference system according to claim 5, further comprising a client device,
wherein the process executed by the second processor further includes
outputting an encrypted inference result obtained by the inference processing to the client device, and
performing the inference processing by computing via a homomorphic encryption scheme, and
wherein the client device includes a third processor configured to execute a process including:
performing encryption processing via the homomorphic encryption scheme on data of a target for the inference processing,
outputting the data encrypted by the performing process executed by the third processer to the inference device, and
performing decryption processing via the homomorphic encryption scheme on the encrypted inference result in response to the encrypted inference result being input.

7. An inference method executed by a processor to control an inference device, the inference method comprising:
a process executed by the processor including:
acquiring a learned model in which a parameter is adjusted by using a first neural network employing a nonlinear function as an activation function, the parameter including at least one of a weight and a bias of coupling between neurons included in the first neural network;
setting a parameter in a second neural network employing an approximation polynomial of the nonlinear function as an activation function in accordance with the learned model; and
performing inference processing on encrypted data as encrypted by using the second neural network in response to the encrypted data being input.

8. A non-transitory computer readable medium storing an inference program for causing a computer to execute an inference process for controlling an inference device: the process comprising:
acquiring a learned mode in which a parameter is adjusted by using a first neural network employing a nonlinear function as an activation function, the parameter including at least one of a weight and a bias of coupling between neurons included in the first neural network;
setting a parameter in a second neural network employing an approximation polynomial of the nonlinear function as an activation function in accordance with the learned model; and
performing inference processing on encrypted data as encrypted by using the second neural network in response to the encrypted data being input.
